(19) United States
(12) Patent Application Publication
(10) Pub. No.: US 2026/0276486 A1
(43) Pub. Date: Sep. 17, 2026

(54) EFFICIENCY OPTIMIZATION AND ANOMALY DETECTION IN HVAC SHELTERS FOR WIRELESS COMMUNICATION FACILITIES

(71) Applicant: AT&T Intellectual Property I, L.P., Atlanta, GA (US)

(72) Inventors: Vladimir Sevastyanov, Fort Worth, TX (US); Rakhi Gupta, Frisco, TX (US); ABHAY DABHOLKAR, ALLEN, TX (US)

(73) Assignee: AT&T Intellectual Property I, L.P., Atlanta, GA (US)

(21) Appl. No.: 19/078,936

(22) Filed: Mar. 13, 2025

(51) Int. Cl. G01M 99/00

(52) U.S. Cl. CPC G01M 99/005

(57) ABSTRACT

Aspects of the subject disclosure may include, for example, retrieving an input dataset comprising energy consumption or cost data and categorical attributes related to a plurality of heating, ventilation and air conditioning (HVAC) shelters for wireless communication facilities of a wireless communication network, building a regression model using a robust model builder algorithm configured to generate predicted energy consumption or cost values representative of HVAC shelters maintained in good technical condition, applying the regression model to the input dataset to calculate, for each HVAC shelter, a predicted energy consumption or cost value and to compute a residual value for each HVAC shelter, forming a set of residual values, identifying anomalous values among the set of residual values, wherein the anomalous values indicate an abnormal energy consumption or cost profile, and generating an alert for a selected HVAC shelter based on the anomalous values. Other embodiments are disclosed.

### FIELD OF THE DISCLOSURE

The subject disclosure relates to optimization of energy consumption and cost efficiency in Heating, Ventilation, and Air Conditioning (HVAC) shelters used in wireless communication facilities, as well as the detection of anomalies in the operation of such facilities.

### BACKGROUND

Wireless communication facilities are a critical part of the telecommunications infrastructure. These facilities often include HVAC shelters that house baseband units (BBUs) which convert signals into a format compatible with remote radio units (RRUs). The BBUs require specific temperature and humidity parameters to function optimally, and the HVAC shelters provide the necessary cooling and heating equipment to maintain these parameters. However, the operation of these HVAC shelters consumes a significant amount of energy, leading to substantial costs for telecom companies.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is an elevation view depicting a conventional wireless communication facility.

FIG. 2B depicts an illustrative embodiment of a method in accordance with various aspects described herein.

FIG. 2C presents a table with input data and prediction results computed by a method in accordance with various aspects described herein.

FIG. 2D illustrates an exemplary distribution of residuals generated by a method in accordance with aspects described herein.

FIG. 2E depicts an illustrative embodiment of a second method in accordance with various aspects described herein.

FIG. 2F presents a table with the average residual value for each state in the United States.

FIG. 2G presents a table with the average residual value for each HVAC system type.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for optimizing energy consumption and detecting anomalies in HVAC shelters used in wireless communication facilities by employing a robust regression model that effectively handles outliers. This model calculates residuals between actual and predicted energy usage to identify outliers, indicating potential issues with HVAC systems, and groups shelters by categorical variables to detect systematic anomalies. The approach enhances operational efficiency, reduces costs, and provides a versatile solution applicable across various industries beyond telecommunications. Other embodiments are described in the subject disclosure.

One or more aspects of the subject disclosure include retrieving an input dataset comprising energy consumption or cost data and categorical attributes related to a plurality of infrastructure facilities for a wireless communication network, applying a regression model to the input dataset to calculate predicted energy consumption or cost values, computing, for each infrastructure facility of the plurality of infrastructure facilities, a residual value, wherein the computing the residual value is based on an actual value and a predicted value, grouping the plurality of infrastructure facilities by one or more categorical variables, forming groups of facilities, and computing average residual values for each group of the group of facilities to identify systematic anomalies, and generating an alert for a selected infrastructure facility of the plurality of infrastructure facilities requiring maintenance, wherein the generating the alert is based on the average residual values.

One or more aspects of the subject disclosure include retrieving an input dataset comprising energy consumption or cost data and categorical attributes related to a plurality of heating, ventilation and air conditioning (HVAC) shelters for wireless communication facilities of a wireless communication network, building a regression model using a robust model builder algorithm configured to generate predicted energy consumption or cost values representative of HVAC shelters maintained in good technical condition, applying the regression model to the input dataset to calculate, for each HVAC shelter, a predicted energy consumption or cost value and to compute a residual value for each HVAC shelter, forming a set of residual values, identifying anomalous values among the set of residual values, wherein the anomalous values indicate an abnormal energy consumption or cost profile, and generating an alert for a selected HVAC shelter based on the anomalous values.

One or more aspects of the subject disclosure include retrieving an input dataset comprising energy consumption or cost data and categorical attributes for a plurality of heating, ventilation and air condition (HVAC) shelters of infrastructure equipment configured to provide wireless communication service on a wireless communication system, applying a regression model to the input dataset to calculate predicted energy consumption or cost values for each HVAC shelter of the plurality of HVAC shelters; computing a set of residual values, each respective residual value corresponding to a variance between a predicted energy consumption or cost value for a respective HVAC shelter, as calculated by the regression model, and a respective energy consumption or cost data value of the input dataset, identifying anomalies among the plurality of HVAC shelters, wherein the identifying the anomalies is based on the set of residual values, and generating an alert for HVAC shelters or groups of HVAC shelters corresponding to the anomalies.

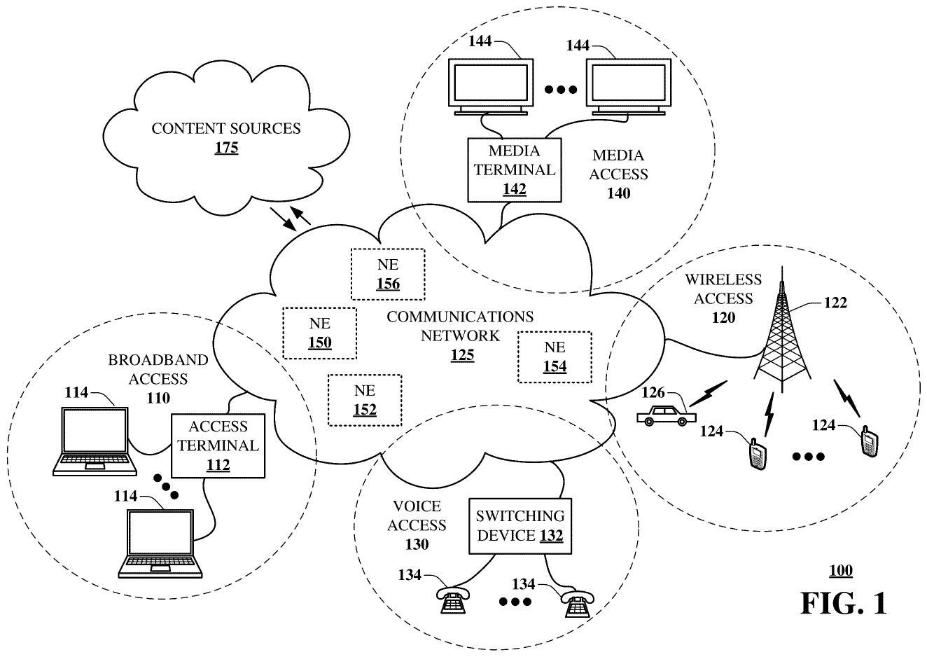

Referring now to FIG. 1, a block diagram is shown illustrating an example, non-limiting embodiment of a system 100 in accordance with various aspects described herein. For example, system 100 can facilitate in whole or in part calculating residuals between actual and predicted energy usage to identify outliers, identifying potential issues with HVAC systems, and grouping shelters by categorical variables to detect systematic anomalies. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Wireless communication facilities, such as those associated with wireless access 120, are a critical part of the telecommunications infrastructure such as communications network 125. Such facilities may include a baseband unit (BBU) in communication with one or more remote radio units (RRU) at a base station site. These facilities often include Heating, Ventilation, and Air Conditioning (HVAC) shelters that house the baseband units (BBUs) which convert signals into a format compatible with the remote radio units (RRUs). The RRUs may be elevated on a pole or tower. The BBUs are contained within a structure and require specific temperature and humidity parameters to function optimally. Generally, the HVAC shelters provide the necessary cooling and heating equipment to maintain these parameters. However, the operation of these HVAC shelters consumes a significant amount of energy, leading to substantial costs for telecom companies.

Most HVAC shelters operate optimally. However, a small percentage of outliers may not function efficiently due to various issues, leading to abnormal energy consumption and higher costs at a particular site or installation. Conventional methods for identifying these outliers may not be effective in all cases. One conventional method, for example, is the Interquartile Range (IQR) method, which is a statistical measure used to understand the spread of a dataset and, importantly, to identify potential outliers. Therefore, there is a need for a more robust and accurate method to identify and address such problematic HVAC shelters, both on an individual and group level, to optimize energy consumption and cost efficiency.

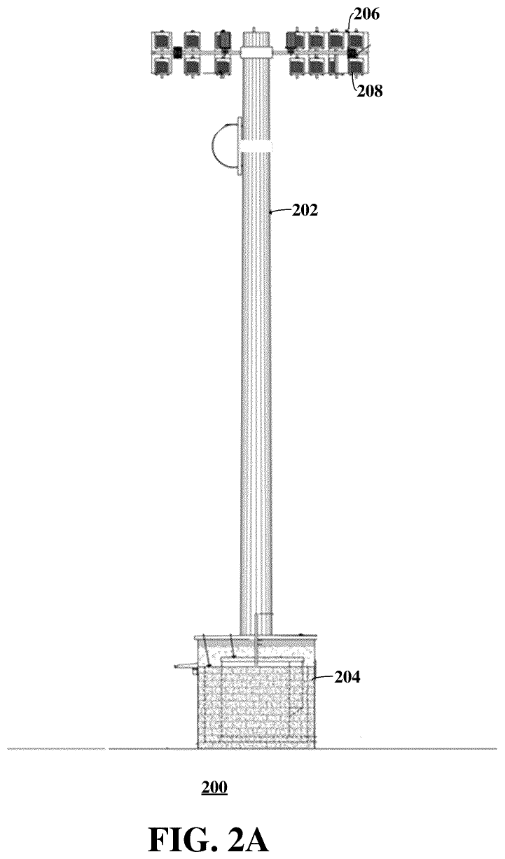

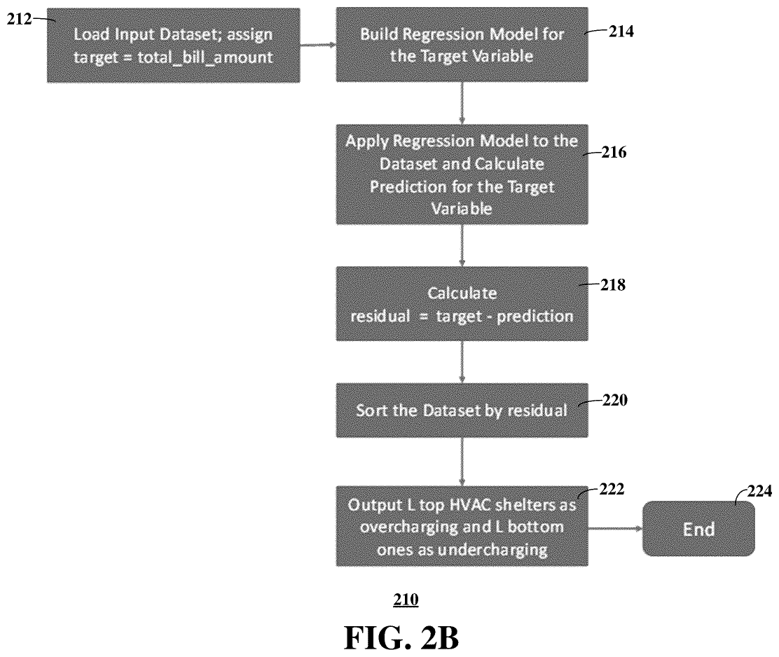

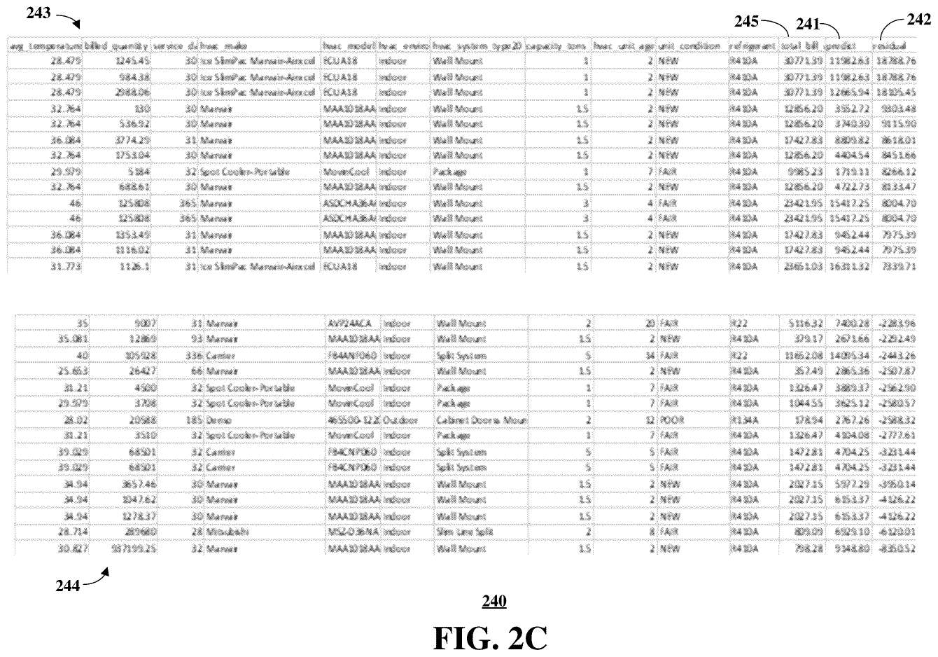

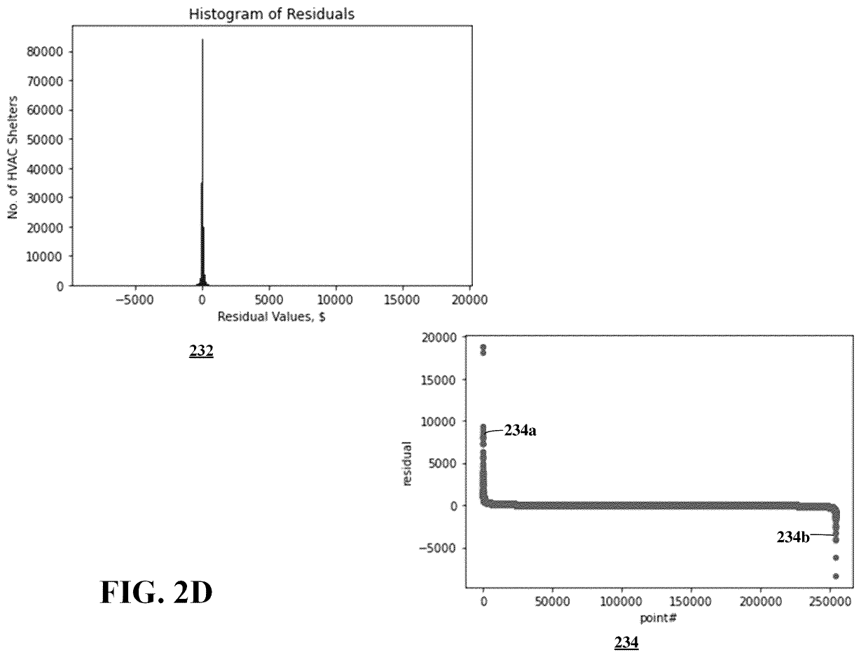

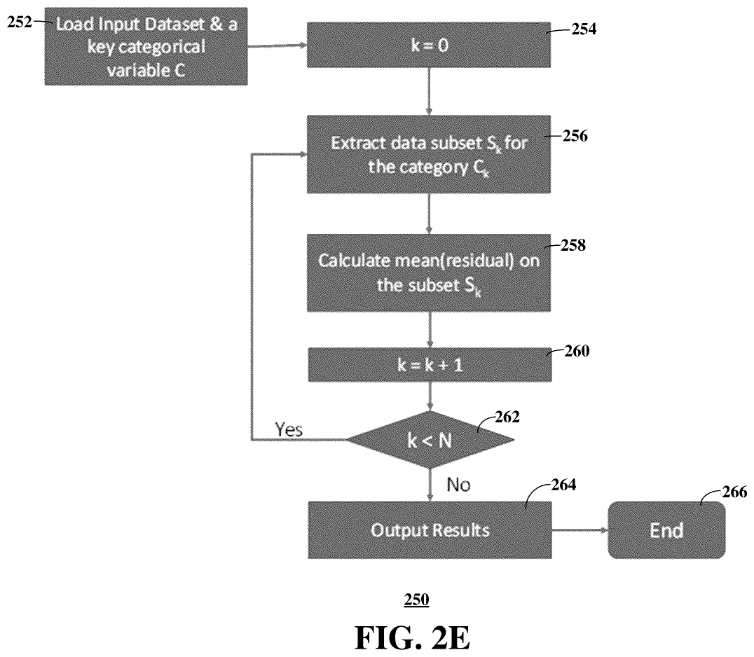

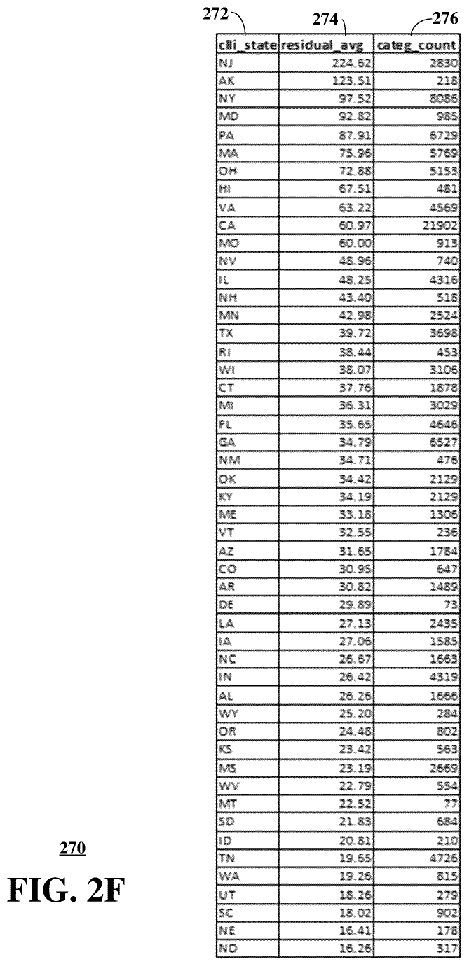

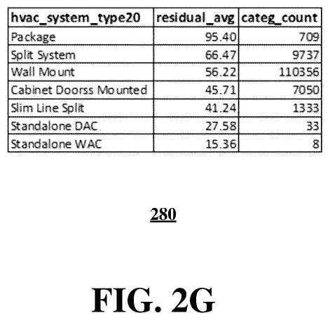

FIG. 2A is an elevation view depicting a conventional wireless communication facility 200. The wireless communication facility 200 may be a base station or cell site such as base station or access point 122 of wireless access 120 of communications network 125. The wireless access 120 may include a large number of base stations or access points such as wireless communication facility 200 to establish a mobility network for user equipment (UE) such as mobile devices 124 and vehicle 126. The wireless communication facility 200 is intended to be exemplary of such network equipment.

The wireless communication facility 200 in this exemplary embodiment includes a monopole 202 and a Heating, Ventilation, and Air Conditioning (HVAC) shelter 204. Mounted on the monopole 202 are an antenna 206 and a remote radio unit (RRU) 208. The HVAC shelter 204 is generally located on the ground and houses a baseband unit (BBU, not shown) which converts signals into a format compatible with the RRU 208. The BBU includes electronic equipment which requires maintenance of consistent temperature and humidity parameters within narrow ranges. HVAC shelters such as the HVAC shelter 204 provide cooling and heating equipment which allow these BBU requirements to be met. The HVAC shelter includes heating and air conditioning equipment and control equipment. A setpoint temperature, such as 27 degrees Celsius, is provided to the control equipment which then functions to actuate the heating equipment and the cooling equipment to maintain the setpoint temperature. Electrical power and other infrastructure is supplied to the HVAC shelter 204 as well as wireline or fiber optic connection to a communication network.

As noted, the wireless communication facility 200 is exemplary of infrastructure equipment maintained by a mobile network operator. The telecommunications industry has approximately 400,000 wireless communication facilities across US territory. For this large number of facilities, cooling and heating equipment consumes a significant amount of energy. The energy in turn incurs a cost, and the total amount for one mobile network operator is approximately $500 million per year.

The majority of HVAC shelters such as HVAC shelter 204 operate optimally and consume a reasonable amount of energy. However, a small portion of such HVAC shelters, for various reasons, do not operate optimally. Abnormal operation may include consuming excess energy and costing more than is typically required. By monitoring power usage at each HVAC shelter or cell site, a mobile network operator can collect information about the operation of the cell site. Based on the power consumption for each cell site or HVAC shelter, the operator can identify sites that are overspending or experiencing excessive power consumption or sites that are underspending or experiencing reduced power consumption. Either condition requires attention. If power consumption is reduced, some equipment such as the HVAC equipment may not be functioning, creating a risk to other equipment. If power consumption is increased, some equipment may be malfunctioning.

The detection of such non-optimal HVAC shelters which incur abnormal costs may provide information about network operation and allow reduction in operating costs and improvement in network operations. However, variation in costs and power consumption may be due to other factors including environmental factors. For example, elevated temperatures in the environment may require additional operation of the air conditioning equipment to keep the BBU at an appropriate operating temperature. However, some sites may be overspending because of an equipment failure that needs to be addressed. The network operator needs to be able to separate normal variation in power consumption from abnormal variation.

Thus, there exists a technical problem with monitoring the functioning of infrastructure equipment in a telecommunications network. The network may include tens of thousands or hundreds of thousands of sites or facilities. A malfunction of equipment such as HVAC equipment may cause severe damage at a particular site, with further effects on the communication network due to equipment outage.

In accordance with various aspects disclosed herein, the detection of non-optimal HVAC shelters may be achieved by the application of robust regression models to optimize energy consumption and detect anomalies in HVAC shelters used in wireless communication facilities. Unlike traditional methods, which often rely on routine maintenance and basic monitoring systems, this technology employs a robust regression model that is resistant to outliers, allowing for the accurate identification of HVAC shelters that deviate from expected energy consumption patterns. By calculating residuals between actual and predicted energy usage, the described technology effectively flags outliers, indicating potential issues with HVAC systems. Additionally, the approach introduces a method to identify problematic groups of HVAC shelters based on categorical variables such as location, manufacturer, and system type, by averaging residual values. This approach not only enhances operational efficiency and reduces costs but also provides a versatile solution applicable across various industries beyond telecommunications.

In this context, outliers may refer to HVAC shelters that exhibit abnormal energy consumption compared to the predicted values generated by the robust regression model. These outliers are identified by calculating the residuals, which are the differences between the actual and predicted energy consumption or cost values. HVAC shelters with high positive residuals are considered to be over-consuming energy, while those with high negative residuals are under-consuming energy. These deviations from the expected energy usage patterns indicate potential issues with the HVAC systems, such as equipment malfunctions or inefficiencies, which may require maintenance or repair. Identifying these outliers enables optimizing energy consumption and reducing operational costs in wireless communication facilities. Conventionally, outliers need to be recognized to remove them from the dataset, rebuild the model and thereby make the model more accurate. A system and method in accordance with the disclosure here is opposite: outliers are not removed but are used as an indication of HVAC shelters belonging to the abnormal distribution.

FIG. 2B depicts an illustrative embodiment of a method 210 in accordance with various aspects described herein. FIG. 2B illustrates a flowchart of method 210 for detecting anomalies in HVAC shelters. Method 210 is implemented within the context of a wireless communication network, as depicted in FIG. 1, and may be applied, for example, to the infrastructure of wireless communication facilities, such as those shown in FIG. 2A.

Method 210 may be performed at any suitable location or processing system in the communications network 125 of FIG. 1. The method 210 may access network information such as current and historical energy consumption or cost data as well as categorical attributes related to HVAC shelters. The categorical attributes may include data defining categories among the energy consumption or cost data such as geographic locations of HVAC shelters, manufacturers of HVAC equipment of models of HVAC equipment, and types of installation of HVAC equipment at particular shelters, as well as environmental conditions over time such as ambient environmental temperature recorded by sensors at HVAC shelters. Energy usage or cost data may be collected from respective HVAC shelters by sensors located at the respective shelters which can provide real-time or near-real-time data over the communications network 125. Reported sensor data, and other information, may be stored in any suitable database or other network location.

Method 210 begins at step 212 with loading an input dataset and assigning the target variable as the total bill amount. The input dataset in exemplary embodiments includes energy consumption or cost data and categorical attributes related to HVAC shelters, which are part of the infrastructure facilities depicted in FIG. 1, such as the HVAC shelter in FIG. 2A. The energy consumption or cost data may include historical or current energy consumption or cost data. The energy consumption or cost data may be expressed in current values such as dollars or in energy units such as kilowatts (kW), or any other suitable value. Moreover, any suitable transformation of the data may be made such as normalization and removing obviously erroneous data. As noted, the total bill amount is designated as the target variable, and this may be expressed as a currency amount. In addition, any suitable value may be designated as the target variable.

The input dataset may include any suitable information such as energy consumption or cost data and categorical attributes related to a plurality of infrastructure facilities for a wireless communication networks. In some examples, the input dataset may include energy consumption or cost data for baseband units (BBUs) or for remote radio units (RRUs) at wireless infrastructure such as cell sites. The energy consumption or cost data may be evaluated as illustrated in FIG. 2B and method 210 to evaluate performance of the infrastructure facilities. Thus, the energy consumption or cost data serves as a stand-in or substitute for other operational data that may not be as readily available in an input dataset.

At step 214, a regression model is built for the target variable using a robust model builder algorithm. Any suitable model building process may be used. A regression model operates to predict the value of a dependent variable, or the target variable, based on the values of one or more independent variables. The regression models seeks to establish the nature and strength of the connection between these variables. This can be, for example, a linear relationship (straight line) or a non-linear relationship (a curve).

In embodiments, the regression model selected to be a robust regression model and is thus designed to handle outliers effectively, ensuring accurate predictions of energy consumption or cost values for the HVAC shelters. Robust regression is a form of regression analysis designed to be less sensitive to outliers in the data. Traditional linear regression can be heavily influenced by outliers. Outliers are extreme values that can significantly distort the regression line, leading to inaccurate predictions and misleading conclusions. Robust regression methods aim to minimize the impact of outliers, providing a more reliable estimate of the relationship between variables. In examples, the robust regression model achieves this by assigning different weights to data points. For example, outliers may receive lower weights, reducing their influence on the regression model. The robust regression model is useful for distinguishing between normal and abnormal power usage based on the dataset including energy consumption or cost data and categorical attributes.

At step 216 of method 210, the regression model is applied to the dataset to calculate predictions for the target variable. Step 216 may involve analyzing the energy consumption data from the HVAC shelters, such as those housed within the wireless communication facilities shown in FIG. 2A. By applying the regression model, energy consumption or cost can be predicted for operation by HVAC systems under normal operating conditions. The result is a prediction dataset.

In exemplary embodiments, the residual is calculated as the difference between the target and prediction values. A residual is calculated for each HVAC shelter. The prediction value is the value produced at step 216 by the regression model for a particular HVAC shelter. The actual value is the value received at step 212 with the input dataset for that particular HVAC shelter. This calculation identifies outliers, which are HVAC shelters that exhibit abnormal energy consumption compared to the predicted values. These outliers are indicative of potential issues with the HVAC systems. Identifying these residuals is helpful for pinpointing shelters that may require maintenance or further investigation.

At step 220, the prediction dataset is sorted by residual values, allowing for the identification of HVAC shelters that are overcharging or undercharging. For example, the residual value for a selected HVAC shelter may be compared with one or more threshold value (expressed in currency values such as dollars, for example). If the residual value for the selected HVAC shelter exceeds a high-charge threshold value, for example, the selected HVAC shelter may be classified as an overcharging shelter. Similarly, if the residual value for the selected HVAC shelter falls below a low-charge threshold value, for example, the selected HVAC shelter may be classified as an undercharging shelter. This sorting process helps prioritize which shelters require immediate attention. By organizing the data in this manner, the system can efficiently target the most problematic shelters for corrective action.

At step 222 of method 210, the top HVAC shelters with the highest residuals are output as overcharging, while the bottom HVAC shelters with the lowest residuals are identified as undercharging. Any suitable number or percentage of HVAC shelters may be designated as overcharging or undercharging or given any other designation or classification. In general, HVAC shelters that are considered anomalies are identified. The anomalies have residual values that correspond to outliers relative to the overall input dataset. The anomalous values may indicate a malfunctioning HVAC shelter or equipment of an HVAC shelter. For example, if the HVAC shelter is overcharging, there may be an electrical malfunction causing increased electric power usage, or a thermal condition causing the increased power consumption. Similarly, if a HVAC shelter is undercharging, the HVAC equipment may not be functioning properly to maintain the designated temperature setpoint. This may create a risk to the electronic equipment of the wireless infrastructure facility, such as a BBU contained in the HVAC shelter.

Step 222 may further include generating alerts for the identified shelters, facilitating timely maintenance actions. These alerts ensure that relevant personnel are notified of potential issues, allowing for quick response and resolution of any anomalies detected by method 210. In some examples, step 222 may include taking corrective action to correct any identified anomalies among the HVAC shelters. Any suitable corrective action may be taken, such as disabling one or more cell site facilities or switching communication traffic to another neighboring facility. In some examples, taking corrective action may include dispatching selected troubleshooting equipment to a site of an anomaly among the HVAC shelters to identify and correct failing equipment. For example, a repair crew of technicians may be dispatched to the anomalous HVAC shelter to identify any problems and correct the problems by repairing or replacing equipment. In another example, communication traffic may be automatically rerouted or switched to a different facility for processing. Such switch may be performed based on for example traffic signal latency. For example, if signal latency exceeds a predetermined threshold value, traffic may automatically be switched or rerouted for alternative processing to maintain acceptable quality of service (QoS) or quality of experience (QoE) for a customer.

The process concludes at step 224, having effectively identified and flagged HVAC shelters that deviate from expected energy consumption patterns. The method 210 outlined in FIG. 2B assists in optimizing energy consumption and detecting anomalies in HVAC shelters. Automated approaches for detecting poor energy consumption in HVAC shelters may involve the use of smart sensors and IoT devices to continuously monitor environmental conditions and energy usage, feeding data into machine learning algorithms and AI systems for real-time analysis and anomaly detection. These systems can predict inefficiencies, diagnose faults, and provide automated responses or alerts to ensure optimal energy performance and quick resolution of any issues. The method 210 leverages the robust regression model to provide accurate and actionable insights. This approach is applicable across the wireless communication network infrastructure depicted in FIG. 1 and specifically targets the HVAC shelters within facilities like those shown in FIG. 2A.

FIG. 2C presents a table 240 with input data and prediction results computed by a method in accordance with various aspects described herein. In an example, an embodiment of the table 240 includes 253,576 rows. Each row corresponds to a single HVAC shelter of a telecommunications network Each row further includes features associated with the HVAC shelter. In the example embodiment, each row includes 32 features, both categorical and numeric. Examples of the features include an average ambient temperature at the HVAC shelter, a billed quantity (such as kilowatts of used power), a manufacturer and model of the HVAC equipment at the shelter, an HVAC system type, capacity, age, condition, and the actual energy consumption or cost data for the selected HVAC shelter. Any combination of features may be displayed or used for analysis or alerting.

In an example, the H2O Gradient Boosting Machine (GBM) algorithm is used to construct a robust regression model for the target variable total_bill_amount. GBM is an ensemble learning method. GBM combines multiple weaker prediction models, such as decision trees, to create a stronger, more accurate model. GBM works by sequentially building trees, where each subsequent tree attempts to correct the errors made by the previous ones. In a regression context, the individual trees within the GBM predict continuous numerical values.

In the example, a regression model was constructed on the entire table 240 with 75% data in the training data set, and 25% of data for the validation dataset with R² or RSQ=0.912. The regression model was applied to the entire dataset to calculate a prediction shown in column 241 and residual shown in column 242. The table 240 was sorted by the residual, column 242. FIG. 2C includes a first table portion 243 showing the top 15 rows of table 240 after sorting-positive residuals. A second table portion 244 shows the bottom 15 rows-negative residuals.

Positive residuals, first table portion 243, correspond to overcharging. For example, the first row of table 240 shows residual value equal to an actual value (column 245) of $30,771.39 minus the predicted value (column 241) of $11,982.63 or the residual value (column 242) of $18,788.76. The actual bill amount column 245, is larger than the predicted amount, column 241 by $18,788.76. This may be due to different possible reasons such as an invalid actual value, fraud; or overcharge of electric energy due to an equipment issue.

In the case of negative residuals, second table portion 244 shows undercharging. The top row of second table portion 244 shows an example of an actual value of $5,116.32 minus a predicted value of $7,400.28 giving a residual value of −$2,283.96. Possible reasons for the residual include an invalid actual value, equipment at the HVAC shelter is out of order and not drawing power. For example, in this case, the communication equipment at the cell site served by the HVAC shelter may be damaged because temperature requirements are not satisfied.

FIG. 2D illustrates an exemplary distribution of residuals generated by a method in accordance with aspects described herein. The distribution includes a histogram 232 and a scatter plot 234. Histogram 232 plots a number of HVAC shelters on the y-axis against calculated residual values on the x-axis. As follows from the histogram 232, the vast majority of residual values are distributed around a residual value of zero. These represent the desired distribution of the HVAC shelters in which the actual value of energy consumption or cost matches the predicted value form the regression model. The abnormal distribution is represented by the left and right branches of the histogram 232. The abnormal distribution has a very low frequency compared with the central part of the histogram 232.

In FIG. 2D, the scatter plot 234 illustrates the dependency of residuals from the point number. The majority of points belong to the almost horizontal part of the graph 410, and their values are close to zero. The vertical part 234a contains positive outliers, and the vertical part 234b contains negative outliers.

Method 210 provided for constructing a regression model on the entire dataset, including both good points and outliers, in such a way that the model is not sensitive to outliers and has high accuracy on good points. As mentioned above, two conditions should be satisfied, including use of a robust model builder algorithm, and a low percentage of outliers. The first condition has been satisfied because of use of the robust GBM algorithm. As can be seen in FIG. 2D visualizing residuals, normal points belong to the interval [−500, 500]. Based on this, 0.5% of outliers and 99.5% of normal points are in the input set of data. Accordingly, the second condition is satisfied as well.

The model's accuracy on good points is: RSQ=0.973 while on the entire dataset RSQ=0.912. This confirms that the GBM was able to ignore outliers and approximate the distribution of total bill amounts for optimal HVAC shelters with high accuracy.

Based on the above considerations, the model predictions on the outliers are concluded to be accurate enough and to provide a good estimation of the expected bill amount value for each outlier. A large residual value for a selected HVAC shelter indicates that the HVAC shelter has issues with its cooling/heating equipment and gives an idea of how much money can be saved if the issue is fixed for a particular shelter.

The above algorithm allows the detection of individual HVAC shelters which consume an abnormal amount of energy and as a result, incur an abnormal cost.

FIG. 2E depicts an illustrative embodiment of a second method 250 in accordance with various aspects described herein. The method 2E relates to an algorithm which allows the detection of a group of problematic HVAC shelters which have the same manufacturer, or the same model, or for instance are located in the same state. The input dataset includes numeric and categorical features. The algorithm associated with method 250 focuses on the categorical features. The method 250 enables investigating how a particular categorical variable impacts the efficiency of HVAC shelters. The variable residual at column 242 of table 240 illustrated in FIG. 2C will be used as a target variable in connection with method 250 in FIG. 2E.

FIG. 2E illustrates a flowchart of method 250 for estimating the impact of categorical variables on the efficiency of HVAC shelters. This method is implemented within the context of a wireless communication network, as depicted in FIG. 1, and is applied to the infrastructure of wireless communication facilities, such as those shown in FIG. 2A.

The process begins with Step 252, where the input dataset and a key categorical variable C are loaded. For this example, consider a categorical variable C={C_1,C_2, . . . , C_N} where C_i, i=1, . . . , N are values (categories) of the categorical variable C. This dataset includes energy consumption or cost data and categorical attributes related to HVAC shelters, which are part of the infrastructure facilities depicted in FIG. 1, such as the HVAC shelter 204 in FIG. 2A.

In Step 254, the index k is initialized to zero. This index is used to iterate through the different categories of the selected categorical variable C. The categorical variables can include attributes such as geographical location, manufacturer, or system type, which are relevant to the operation and efficiency of the HVAC shelters within the wireless communication facilities.

Step 256 involves extracting a data subset Sₖ for the category Cₖ. This step focuses on isolating the data related to a specific category of the categorical variable C. For example, if the categorical variable is the state or other geographical region in which the HVAC shelter is located, this step extracts data for all shelters within a particular state. This allows for a focused analysis of how each category impacts energy consumption and efficiency.

In step 258, the mean of the residual values is calculated for the subset Sₖ. The residual values, which are the differences between actual and predicted energy consumption or cost values, provide insight into the efficiency of the HVAC shelters within the specific category. This calculation helps identify systematic anomalies that may be present in certain categories.

At step 260 the index k is incremented by one, preparing the process to analyze the next category in the categorical variable C. This iterative approach ensures that each category is thoroughly evaluated for its impact on the efficiency of the HVAC shelters.

In step 262, a check is performed to determine if k is less than N, where N is the total number of categories in the categorical variable C. If k is less than N, the process returns to step 256 to extract and analyze the next data subset. This loop continues until all categories have been evaluated.

Finally, step 264 generates the results as an output. The results in this example include the average residual values for each category. These results provide valuable insights into which categories systematically cause higher energy consumption and costs. The method 250 outlined in FIG. 2E is useful for optimizing energy consumption and detecting anomalies in HVAC shelters, as the method 250 leverages categorical analysis to provide accurate and actionable insights. This approach is applicable across the wireless communication network infrastructure depicted in FIG. 1 and specifically targets the HVAC shelters within facilities like those shown in FIG. 2A.

FIG. 2F presents a table 270 with the average residual value for each state in the United States. FIG. 2F 6 illustrates the case with the categorical variable C set to clli_state. Column 272 contains values of the categorical variable clli_state. Column 274 contains average values of residuals for each state. Column 276 contains the number of records in each subset S_(k)? DS for k=0, . . . ,50, where 50 is the number of states in the USA. In this example, the table 270 indicates that the least efficient HVAC shelters operate in the state of New Jersey, with an average residual of 224.62. The number of shelters for New Jersey is 2830. It may be estimated that the network operator overpays in New Jersey compared with the baseline: 224.62*2830=$635,674.60.

Conversely, according to this example, the most efficient shelters are located in North Dakota, with an average residual of 16.26. Such analysis shows a very interesting result. HVAC shelters in New Jersey cost much more than in any other state. It is unlikely to be a computational mistake because the average value is calculated over 2830 locations.

Another example uses a categorical variable of manufacturer of HVAC shelters. Such data indicates that HVAC shelters manufactured by the most expensive manufacturer are the most expensive in terms of electricity cost, an extra $352.79 compared with the baseline. The least expensive manufacturer is associated with shelters costing just $13.47. This kind of estimation is important information for the network operator. The reason for such high electricity cost should be investigated. But the first impression is that the most expensive manufacturer's shelters are the worst possible choice. Use of the other brands could be 6-7 times more efficient.

FIG. 2G presents a table 280 with the average residual value for each HVAC system type. As indicated in the figure, example system types include a package type, a split system type, a wall mount type, and others. As follows from the table 280, HVAC shelters using the system type Package are the most expensive in terms of electricity cost, adding an extra $95.40 compared with the baseline. Similarly, the system type Standalone WAC shelter type adds just $15.36 relative to baseline.

Examples including those show in FIG. 2F and FIG. 2G illustrate that calculating average residual values for a group of HVAC shelters collected for different categories of a given categorical variable allows the identification of problematic categories which systematically create issues that cause consuming more energy and spending more money to cover expenses. For instance, the average residual in New Jersey is 14 times larger than in North Dakota. These examples illustrate the ability of the method 210 and the method 250 to detect issues in very different aspects of a telecommunications business. Such information may be interpreted and explained by qualified engineers and can be used to make appropriate business decisions to resolve the issues.

While for purposes of simplicity of explanation, the respective processes are shown and described as a series of blocks in FIG. 2B and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In considering alternate embodiments of the subject disclosure, several variations can be applied to enhance or modify the existing system and methods described in FIG. 1, FIG. 2A, FIG. 2B, and FIG. 2E. One potential embodiment involves integrating advanced machine learning algorithms, such as neural networks or support vector machines, to predict energy consumption patterns. These models may learn from historical data and improve their accuracy over time, adapting to changes in environmental conditions or equipment performance. Additionally, the system may be enhanced in some embodiments to process real-time data streams from sensors installed in HVAC shelters, allowing for immediate detection of anomalies and enabling dynamic adjustments to the regression model for more timely alerts and maintenance recommendations.

The method 250 described in connection with FIG. 2E may be expanded in embodiments to include additional categorical variables, such as time of year, specific weather conditions, or operational schedules of the wireless communication facilities, providing a more comprehensive analysis of factors affecting energy consumption. An alternate embodiment may also include a predictive maintenance module that uses residual values and categorical analysis to schedule maintenance activities proactively, helping to prevent equipment failures and optimize maintenance resources. Furthermore, the system may be integrated with broader energy management systems used by telecom operators, allowing for coordinated energy-saving strategies across multiple facilities and leveraging insights from the HVAC shelter analysis to optimize overall energy usage.

Enhancements to a user interface may provide visualizations of energy consumption patterns, anomaly detection results, and maintenance schedules, thereby enhancing user interaction and facilitating decision-making for facility managers. While the current disclosure focuses on wireless communication facilities, the methods and systems may be adapted for use in other industries, such as data centers, manufacturing plants, or commercial buildings, by tailoring the regression models and categorical variables to the specific energy consumption characteristics of these environments. Additionally, the system may leverage Internet of Things (IoT) devices to gather more granular data on HVAC performance, environmental conditions, and energy usage, enhancing the accuracy of the regression models and providing deeper insights into the factors driving energy consumption. These alternate embodiments demonstrate the flexibility and adaptability of the subject disclosure, allowing it to be tailored to various operational contexts and technological advancements.

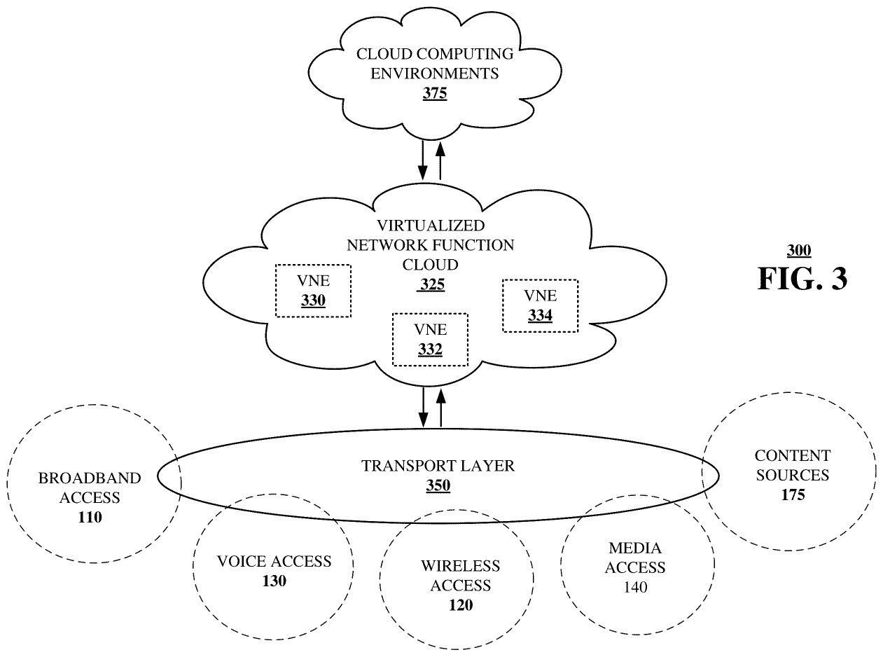

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of method 210 and method 250 presented in FIG. 1, FIG. 2A, FIG. 2B, FIG. 2E, and 3. For example, virtualized communication network 300 can facilitate in whole or in part calculating residuals between actual and predicted energy usage to identify outliers, identifying potential issues with HVAC systems, and grouping shelters by categorical variables to detect systematic anomalies.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

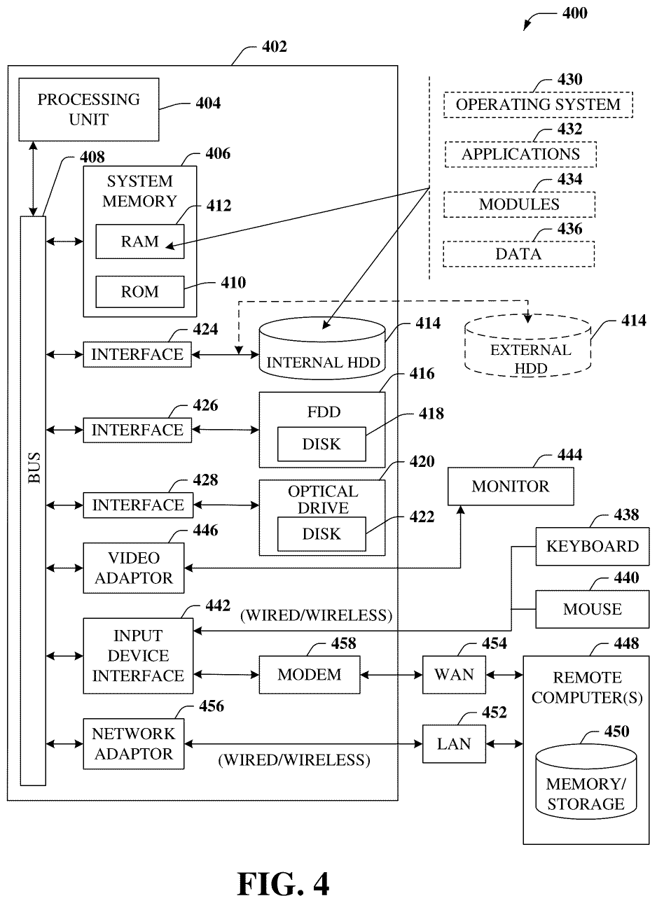

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part calculating residuals between actual and predicted energy usage to identify outliers, identifying potential issues with HVAC systems, and grouping shelters by categorical variables to detect systematic anomalies.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

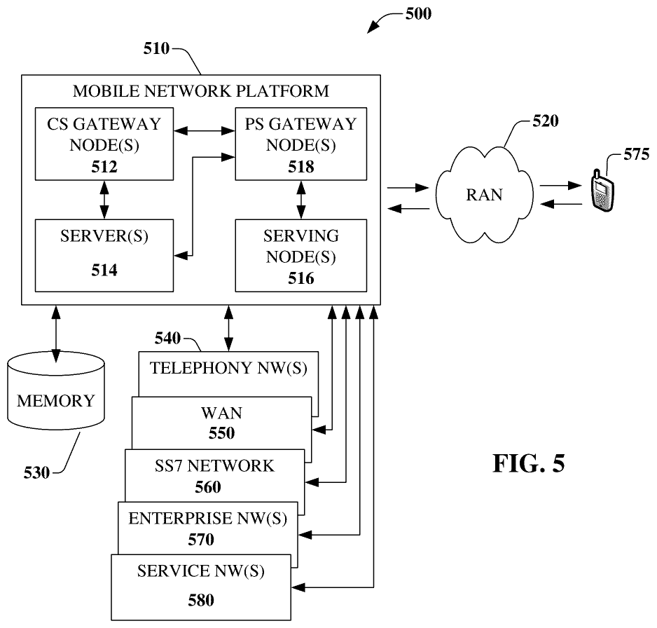

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part calculating residuals between actual and predicted energy usage to identify outliers, identifying potential issues with HVAC systems, and grouping shelters by categorical variables to detect systematic anomalies. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

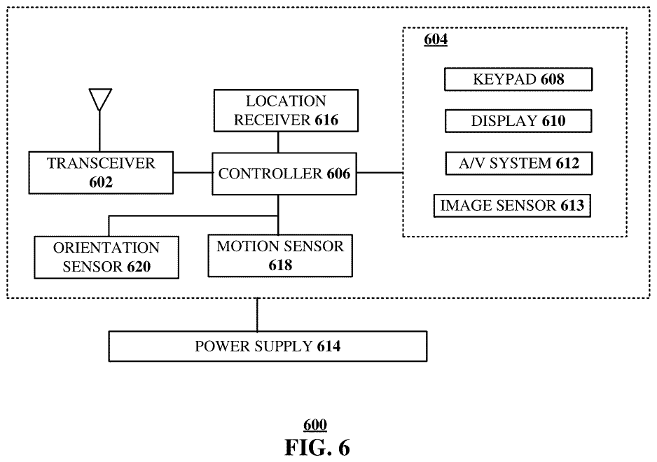

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part calculating residuals between actual and predicted energy usage to identify outliers, identifying potential issues with HVAC systems, and grouping shelters by categorical variables to detect systematic anomalies.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, the use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
retrieving an input dataset comprising energy consumption or cost data and categorical attributes related to a plurality of infrastructure facilities for a wireless communication network;
applying a regression model to the input dataset to calculate predicted energy consumption or cost values;
computing, for each infrastructure facility of the plurality of infrastructure facilities, a residual value, wherein the computing the residual value is based on an actual value and a predicted value;
grouping the plurality of infrastructure facilities by one or more categorical variables, forming groups of facilities, and computing average residual values for each group of the group of facilities to identify systematic anomalies; and
generating an alert for a selected infrastructure facility of the plurality of infrastructure facilities that requires maintenance, wherein the generating the alert is based on the average residual values.

2. The device of claim 1, wherein the retrieving the input dataset comprises:
retrieving an input dataset comprising energy consumption or cost data and categorical attributes related to heating, ventilation and air conditioning (HVAC) shelters for wireless communication sites of the wireless communication network.

3. The device of claim 2, wherein the operations further comprise:
building the regression model using a robust model builder algorithm to establish a baseline representing HVAC shelters maintained in good technical condition.

4. The device of claim 3, wherein the operations further comprise:
applying the regression model to the input dataset to calculate predicted energy consumption or cost values and to compute, for each HVAC shelter, a residual energy consumption value defined as a difference between an actual energy consumption value and a predicted energy consumption value for the HVAC shelter.

5. The device of claim 4, wherein the operations further comprise:
sorting HVAC shelters of the HVAC shelters based on computed residual values to identify outliers corresponding to HVAC shelters that exhibit an abnormal amount of energy consumption or cost;
grouping the HVAC shelters of the HVAC shelters by one or more categorical variables;
identifying anomalies among the HVAC shelters of the HVAC shelters; and
taking corrective action to correct the anomalies among the HVAC shelters of the HVAC shelters.

6. The device of claim 5, wherein the taking corrective action to correct the anomalies among the HVAC shelters comprises:
dispatching troubleshooting equipment to a site of an anomaly among the HVAC shelters to identify and correct failing equipment.

7. The device of claim 1, wherein the computing the residual value comprises:
computing a difference between the actual value and the predicted value.

8. The device of claim 1, wherein the applying a regression model to the input dataset comprises:
applying a robust regression model designed to effectively handle outliers in the input dataset.

9. The device of claim 1, wherein the grouping the plurality of infrastructure facilities by one or more categorical variables comprises:
the grouping the plurality of infrastructure facilities according to location, manufacturer, or model to enhance anomaly detection.

10. The device of claim 1, wherein the operations further comprise:
receiving data from real-time sensors associated with the plurality of infrastructure facilities, wherein the real-time sensors provide current energy consumption and cost data for analysis.

11. A non-transitory machine-readable medium, comprising executable instructions that, when executed by a processing system including a processor, facilitate performance of operations, the operations comprising:
retrieving an input dataset comprising energy consumption or cost data and categorical attributes related to a plurality of heating, ventilation and air conditioning (HVAC) shelters for wireless communication facilities of a wireless communication network;
building a regression model using a robust model builder algorithm configured to generate predicted energy consumption or cost values representative of HVAC shelters maintained in good technical condition;
applying the regression model to the input dataset to calculate, for each HVAC shelter, a predicted energy consumption or cost value and to compute a residual value for each HVAC shelter, forming a set of residual values;
identifying anomalous values among the set of residual values, wherein the anomalous values indicate an abnormal energy consumption or cost profile; and
generating an alert for a selected HVAC shelter based on the anomalous values.

12. The non-transitory machine-readable medium of claim 11, wherein the operations further comprise:
receiving current energy consumption and cost data from real-time sensors associated with the plurality of HVAC shelters;
providing the current energy consumption and cost data to the input dataset for analysis; and
building the regression model based at least in part on the current energy consumption and cost data of the input dataset.

13. The non-transitory machine-readable medium of claim 11, wherein the operations further comprise:
computing a residual value based on a difference between an actual energy consumption or cost value and a predicted energy consumption or cost values.

14. The non-transitory machine-readable medium of claim 11, wherein the operations further comprise:
grouping the plurality of HVAC shelters by one or more categorical variables selected from the group consisting of geographical location, manufacturer, model, network model and system type; and
identifying anomalous values among the set of residual values based on the grouping.

15. The non-transitory machine-readable medium of claim 11, wherein the operations further comprise:
taking corrective action to correct an anomalous value among the HVAC shelters, including dispatching troubleshooting equipment and crew to a site of an HVAC shelter corresponding to an anomalous among the HVAC shelters, including dispatching the troubleshooting equipment and crew to identify and correct failing equipment.

16. A method, comprising:
retrieving, by a processing system including a processor, an input dataset comprising energy consumption or cost data and categorical attributes for a plurality of heating, ventilation and air conditioning (HVAC) shelters of infrastructure equipment configured to provide wireless communication service on a wireless communication system;
applying, by the processing system, a regression model to the input dataset to calculate predicted energy consumption or cost values for each HVAC shelter of the plurality of HVAC shelters;
computing, by the processing system, a set of residual values, each respective residual value corresponding to a variance between a predicted energy consumption or cost value for a respective HVAC shelter, as calculated by the regression model, and a respective energy consumption or cost data value of the input dataset;
identifying, by the processing system, anomalies among the plurality of HVAC shelters, wherein the identifying the anomalies is based on the set of residual values; and
generating, by the processing system, an alert for HVAC shelters or groups of HVAC shelters corresponding to the anomalies.

17. The method of claim 16, wherein the identifying the anomalies among the plurality of HVAC shelters comprises:
identifying, by the processing system, the anomalies based on computed residual values exceeding a predetermined threshold.

18. The method of claim 16, further comprising:
receiving, by the processing system, current energy consumption or cost data; and
updating, by the processing system, the regression model based on the energy consumption or cost data, the updating to improve prediction accuracy and anomaly detection over time.

19. The method of claim 16, wherein the generating the alert comprises:
generating, by the processing system, automated recommendations for corrective actions, including scheduling a maintenance procedure or scheduling an equipment check, based on a determined severity of a detected anomaly among the anomalies.

20. The method of claim 16, wherein the generating the alert comprises:
generating, by the processing system, alerts are through multiple communication channels, including email, messaging, and a dedicated monitoring dashboard, to ensure timely notification of the anomalies to relevant personnel.
